(19) United States
(12) Patent Application Publication
(10) Pub. No.: US 2008/0127224 A1
(43) Pub. Date: May 29, 2008

(54) Method of pre-processing for dynamic removal of a graphics display device from a computing apparatus

(76) Inventor: Donald Hung, Taipei City (TW)

Correspondence Address: DAVIDSON BERQUIST JACKSON & GOWDEY LLP, 4300 WILSON BLVD., 7TH FLOOR, ARLINGTON, VA, 22203, US

(21) Appl. No.: 11/492,107

(22) Filed: Jul. 25, 2006

(30) Foreign Application Priority Data
Mar. 30, 2006 (TW) 095111181

(51) Int. Cl. G06F 9/00

(52) U.S. Cl. 719/321

(57) ABSTRACT

In a method of pre-processing for dynamic removal of a graphics display device from a computing apparatus, upon receipt of a command to remove the graphics display device, an address of the graphics display device to be removed is obtained based on the command. A driver module of the graphics display device to be removed is then notified to release system resources of the computing apparatus allocated to the graphics display device to be removed. Thereafter, an operating system of the computing apparatus is notified to inquire the driver module of a current state of the graphics display device to be removed so as to acquire a response from the driver module indicating that the graphics display device is in an unused state, thereby terminating use of the graphics display device to be removed.

### CROSS-REFERENCE TO RELATED APPLICATION

This application claims priority of Taiwanese Application No. 095111181, filed on Mar. 30, 2006.

### BACKGROUND OF THE INVENTION

1. Field of the Invention

The invention relates to a computing apparatus, more particularly to a method of pre-processing for dynamic removal of a graphics display device from a computing apparatus.

2. Description of the Related Art

At present, a PCMCIA interface cannot achieve stable data transmission for a graphics display device due to its insufficient frequency band, whereas device interfaces, such as a PCI-Express interface, a PCI-16X interface and a USB2.0 interface, can achieve stable data transmission for a graphics display device at a high speed, and a current operating system of a computing apparatus permits dynamic coupling of such a device interface with a graphics display device. In other words, an external graphics display device can be directly coupled to such a device interface even if the computing apparatus is operated in an ON-state.

FIG. 1 illustrates how a computing apparatus performs dynamic connection between a graphics display device and a device interface of the computing apparatus, such as a PCI-Express interface, a PCI-16X interface or a USB2.0 interface. In step 1, the device interface sends an interrupt signal to an operating system of the computing apparatus upon detection of the graphics display device coupled thereto. In step 2, an address of the graphics display device is obtained based on the interrupt signal such that the operating system allocates system resources to the graphics display device coupled to the device interface based on the address. In step 3, the operating system installs a driver module compatible with the graphics display device therein, and then initializes the driver module for the graphics display device.

However, the operating system does not support dynamic removal of the graphics display device from the computing apparatus, i.e., it is only after the computing apparatus has been shut down that the graphics display device can be removed from the device interface, thereby resulting in inconvenience during use.

### SUMMARY OF THE INVENTION

Therefore, the object of the present invention is to provide a method of pre-processing for dynamic removal of a graphics display device from a computing apparatus that can overcome the aforesaid drawbacks of the prior art.

According to one aspect of the present invention, there is provided a method of pre-processing for dynamic removal of a graphics display device from a computing apparatus. The computing apparatus includes a motherboard that has a device interface for coupling with the graphics display device to be removed. The method comprises the steps of:

a) upon receipt of a command to remove the graphics display device, obtaining an address of the graphics display device to be removed based on the command;

b) notifying a driver module of the graphics display device to be removed to release system resources of the computing apparatus allocated to the graphics display device to be removed; and

c) notifying an operating system of the computing apparatus to inquire the driver module of a current state of the graphics display device to be removed so as to acquire a response from the driver module indicating that the graphics display device is in an unused state, thereby terminating use of the graphics display device to be removed.

According to another aspect of the present invention, there is provided a computer program product for a computing apparatus. The computing apparatus includes a motherboard that has a device interface for coupling with a graphics display device to be removed. The computer program product comprises program instructions for causing the computing apparatus to perform consecutive steps of a method of pre-processing for dynamic removal of the graphics display device from the computing apparatus. The method comprises:

upon receipt of a command to remove the graphics display device, obtaining an address of the graphics display device to be removed based on the command;

notifying a driver module of the graphics display device to be removed to release system resources of the computing apparatus allocated to the graphics display device to be removed; and

notifying an operating system of the computing apparatus to inquire the driver module of a current state of the graphics display device to be removed so as to acquire a response from the driver module indicating that the graphics display device is in an unused state, thereby terminating use of the graphics display device to be removed.

According to a further aspect of the present invention, there is provided a computer program product for a computing apparatus. The computing apparatus includes a motherboard that has a device interface for coupling with a graphics display device. The computer program product enables the computing apparatus to perform pre-processing for dynamic removal of the graphics display device from the computing apparatus. The computer program product comprises:

a computer readable storage medium comprising:
a first code that directs the computing apparatus to determine whether a command to remove the graphics display device is received thereby;
a second code that directs the computing apparatus to obtain an address of the graphics display device to be removed based on the command received thereby;
a third code that directs the computing apparatus to notify a driver module of the graphics display device to be removed to release system resources of the computing apparatus allocated to the graphics display device to be removed;
a fourth code that directs the computing apparatus to notify an operating system of the computing apparatus to inquire the driver module of a current state of the graphics display device to be removed; and
a fifth code that directs the computing apparatus to acquire a response from the driver module indicating that the graphics display device is in an unused state, thereby terminating use of the graphics display device to be removed.

### BRIEF DESCRIPTION OF THE DRAWINGS

Other features and advantages of the present invention will become apparent in the following detailed description of the preferred embodiment with reference to the accompanying drawings, of which:

FIG. 1 is a schematic diagram illustrating how a computing apparatus performs dynamic connection between a graphics display device and the computing apparatus; and

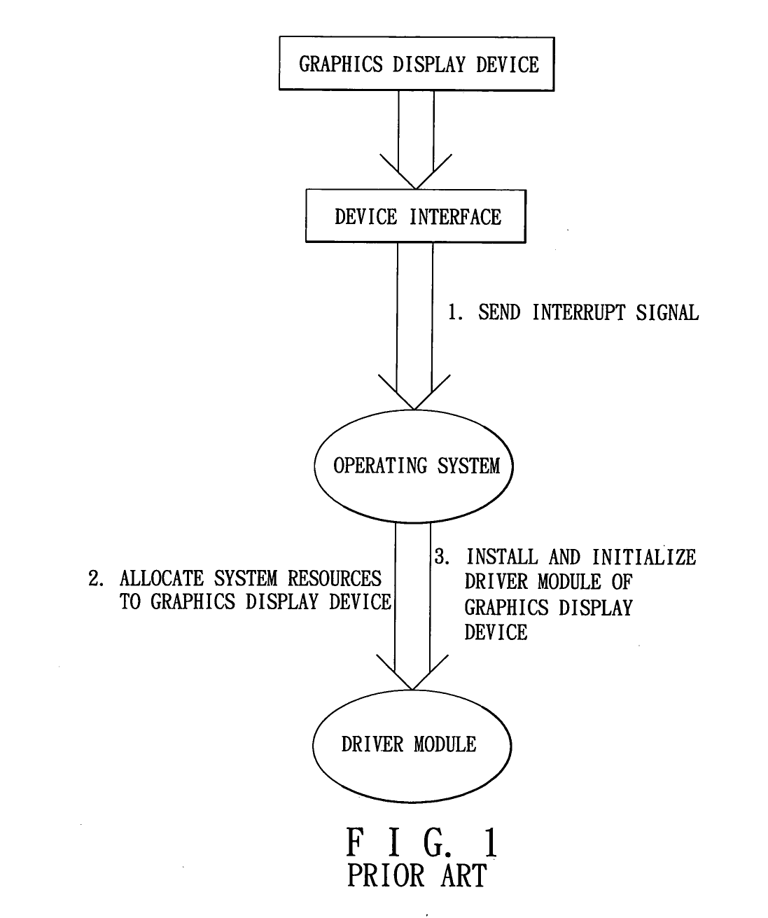

FIG. 2 is a flow chart illustrating how a computing apparatus is configured to perform the preferred embodiment of a method of pre-processing for dynamic removal of a graphics display device from the computing apparatus according to the present invention.

### DETAILED DESCRIPTION OF THE PREFERRED EMBODIMENT

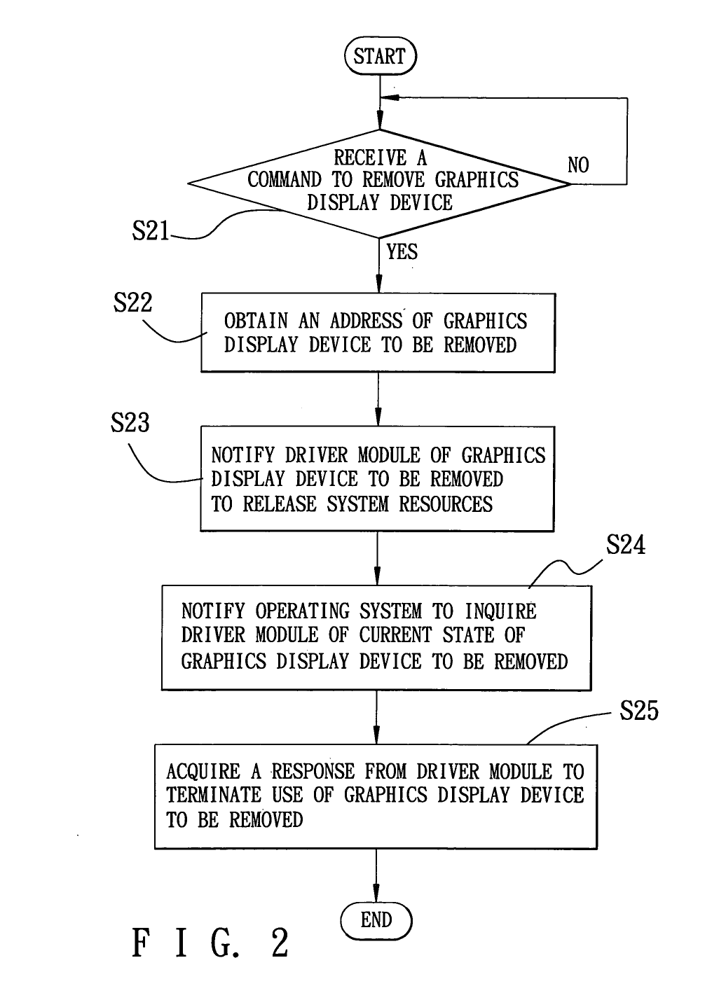

Referring to FIG. 2, there is shown a flow chart to illustrate how a computing apparatus is configured by a computer program product to perform the preferred embodiment of a method of pre-processing for dynamic removal of a graphics display device, such as a graphics card and a graphic display box, from the computing apparatus according to the present invention. The computing apparatus includes a motherboard that has a device interface for coupling with the graphics display device. In this embodiment, the device interface can be one of a PCI-Express interface, a PCI-16X interface and a USB2.0 interface.

In step S21, the computer program product configures the computing apparatus to determine whether a command to remove the graphics display device is received thereby. In this embodiment, the command can be generated via operation of an input interface of the computing apparatus. If yes, the flow proceeds to step S22. On the other hand, if no, step S21 is repeated.

In step S22, the computer program product configures the computing apparatus to obtain an address of the graphics display device to be removed based on the command received thereby. In this embodiment, the address of the graphics display device is obtained from address data recorded by an operating system of the computing apparatus by inquiring the operating system based on the command.

In step S23, the computer program product configures the computing apparatus to notify a driver module of the graphics display device to be removed to release system resources, such as a memory, an I/O port, etc., of the computing apparatus allocated to the graphics display device to be removed. At this time, no power is supplied to the graphics display device to be removed via the device interface.

In step S24, the computer program product configures the computing apparatus to notify the operating system to inquire the driver module of a current state of the graphics display device to be removed.

In step S25, the computer program product configures the computing apparatus to acquire a response from the driver module indicating that the graphics display device is in an unused state, thereby terminating use of the graphics display device to be removed. At the same time, an icon representing the graphics display device to be removed is removed from a file manager of the computing apparatus. Thereafter, the graphics display device to be removed can be directly removed from the device interface.

As such, prior to physical removal of the graphics display device, since the system resources allocated to the graphics display device to be removed were released, and since the power supplied to the graphics display device to be removed was cut off, subsequently, the graphics display device to be removed can be directly removed from the device interface without damaging the motherboard even if the computing apparatus is operated in an ON-state.

While the present invention has been described in connection with what is considered the most practical and preferred embodiment, it is understood that this invention is not limited to the disclosed embodiment but is intended to cover various arrangements included within the spirit and scope of the broadest interpretation so as to encompass all such modifications and equivalent arrangements.

I claim:

1. A method of pre-processing for dynamic removal of a graphics display device from a computing apparatus, the computing apparatus including a motherboard that has a device interface for coupling with the graphics display device to be removed, said method comprising the steps of:
a) upon receipt of a command to remove the graphics display device, obtaining an address of the graphics display device to be removed based on the command;
b) notifying a driver module of the graphics display device to be removed to release system resources of the computing apparatus allocated to the graphics display device to be removed; and
c) notifying an operating system of the computing apparatus to inquire the driver module of a current state of the graphics display device to be removed so as to acquire a response from the driver module indicating that the graphics display device is in an unused state, thereby terminating use of the graphics display device to be removed.

2. The method as claimed in claim 1, wherein step a) further includes the sub-step of:
inquiring the operating system based on the command so as to obtain the address of the graphics display device from address data recorded by the operating system.

3. The method as claimed in claim 1, wherein the device interface is one of a PCI-Express interface, a PCI-16X interface and a USB2.0 interface.

4. The method as claimed in claim 1, wherein, subsequent to step c), the graphics display device to be removed is capable of being directly removed from the device interface.

5. A computer program product for a computing apparatus, the computing apparatus including a motherboard that has a device interface for coupling with a graphics display device to be removed, said computer program product comprising program instructions for causing the computing apparatus to perform consecutive steps of a method of pre-processing for dynamic removal of the graphics display device from the computing apparatus, said method comprising:
upon receipt of a command to remove the graphics display device, obtaining an address of the graphics display device to be removed based on the command;
notifying a driver module of the graphics display device to be removed to release system resources of the computing apparatus allocated to the graphics display device to be removed; and
notifying an operating system of the computing apparatus to inquire the driver module of a current state of the graphics display device to be removed so as to acquire a response from the driver module indicating that the graphics display device is in an unused state, thereby terminating use of the graphics display device to be removed.

6. The computer program product as claimed in claim 5, wherein the address of the graphics display device is obtained from address data recorded by the operating system by inquiring the operating system based on the command.

7. The computer program product as claimed in claim 5, wherein the device interface is one of a PCI-Express interface, a PCI-16X interface and a USB2.0 interface.

8. The computer program product as claimed in claim 5, wherein, after terminating the use of the graphics display device to be removed, the graphics display device is capable of being directly removed from the device interface.

9. A computer program product for a computing apparatus, the computing apparatus including a motherboard that has a device interface for coupling with a graphics display device, said computer program product enabling the computing apparatus to perform pre-processing for dynamic removal of the graphics display device from the computing apparatus, said computer program product comprising:
a computer readable storage medium comprising:
a first code that directs the computing apparatus to determine whether a command to remove the graphics display device is received thereby;
a second code that directs the computing apparatus to obtain an address of the graphics display device to be removed based on the command received thereby;
a third code that directs the computing apparatus to notify a driver module of the graphics display device to be removed to release system resources of the computing apparatus allocated to the graphics display device to be removed;
a fourth code that directs the computing apparatus to notify an operating system of the computing apparatus to inquire the driver module of a current state of the graphics display device to be removed; and
a fifth code that directs the computing apparatus to acquire a response from the driver module indicating that the graphics display device is in an unused state, thereby terminating use of the graphics display device to be removed.
